(19) United States
(12) Patent Application Publication
(10) Pub. No.: US 2005/0026776 A1
(43) Pub. Date: Feb. 3, 2005

(54) Preparation method of catalysts for fischer-tropsch synthesis

(76) Inventors: Muneyoshi Yamada, Sendai-shi (JP); Naoto Koizumi, Sendai-shi (JP); Takehisa Mochizuki, Sendai-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/853,192

(22) Filed: May 26, 2004

(30) Foreign Application Priority Data
Jul. 29, 2003 (JP) 2003-281798

(51) Int. Cl. B01J 23/75

(52) U.S. Cl. 502/260

(57) ABSTRACT

A preparation method of catalysts for Fischer-Tropsch synthesis comprises preparing a solution containing a chelate complex having a transition metal capable of hydrogenating carbon monoxide, allowing silica as a carrier to be impregnated with the solution, drying the silica carrier impregnated with the solution, and baking the silica carrier after the drying so as to permit the oxide of the transition metal to be supported by the silica carrier.

### CROSS-REFERENCE TO RELATED APPLICATIONS

This application is based upon and claims the benefit of priority from prior Japanese Patent Application No. 2003-281798, filed Jul. 29, 2003, the entire contents of which are incorporated herein by reference.

### BACKGROUND OF THE INVENTION

1. Field of the Invention

The present invention relates to a preparation method of catalysts for Fischer-Tropsch synthesis.

2. Description of the Related Art

Fischer-Tropsch synthesis (FT synthesis) denotes the reaction for synthesizing hydrocarbons from a synthetic gas (CO+H₂) derived from non-petroleum carbon resources such as natural gas, biomass and coal.

If a Co catalyst is used in FT synthesis, it is possible to obtain linear hydrocarbons having a high molecular weight. The linear hydrocarbons thus obtained have attracted attention as a high-quality diesel fuel. In preparing the Co catalyst, it is reported that Co species can be formed in a highly dispersed state on alumina or titania by mixing cobalt nitrate as a precursor with EDTA (ethylenediamine tetraacetic acid) and citric acid.

However, the Co catalyst thus obtained is hardly reduced into cobalt metal and, thus, hardly exhibits an activity.

### BRIEF SUMMARY OF THE INVENTION

An object of the present invention is to provide a preparation method of catalysts for Fischer-Tropsch synthesis, the catalysts permitting a high CO conversion rate and exhibiting high activity.

According to an aspect of the present invention, there is provided a preparation method of catalysts for Fischer-Tropsch synthesis, comprising:
preparing a solution containing a chelate complex having a transition metal capable of hydrogenating carbon monoxide;
impregnating silica used as a carrier with the solution;
drying the silica carrier impregnated with the solution; and
baking the dried silica carrier so as to permit the oxide of the transition metal to be supported by the silica carrier.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DETAILED DESCRIPTION OF THE INVENTION

Some embodiments of the present invention will now be described.

In the preparation method of catalysts for FT synthesis according to one embodiment of the present invention, the transition metal capable of hydrogenating carbon monoxide is used in the form of a chelate complex.

The transition metal capable of hydrogenating carbon monoxide includes, for example, cobalt, nickel, iron, copper, chromium, manganese, zirconium, molybdenum, tungsten, rhenium, osmium, iridium, palladium, silver, ruthenium, rhodium, and platinum. Particularly, it is desirable to use cobalt, iron and ruthenium for synthesizing high molecular weight hydrocarbons.

The transition metal can be used in the form of at least a metal compound selected from the group consisting of a metal nitrate, a carbonate, an organic acid, an oxide, a hydroxide, a halide, a cyanide, a hydroxide, and a halogen. Particularly, it is desirable to use a nitrate or an acetate of the transition metal. The metal compounds can be used singly or in the form of a mixture of at least two of these compounds.

The chelate complex can be formed by allowing a chelating agent or an organic acid to act on the metal compound referred to above.

It is possible to use, for example, nitrilotriacetic acid (NTA), trans-1,2-cyclohexadiamine-N,N,N′,N′-tetraacetic acid (CyDTA), and ethylenediamine tetraacetic acid (EDTA) as the chelating agent. Also, the organic acid includes, for example, glycine, aspartic acid and citric acid.

The solution (impregnating solution) is prepared by dissolving the metal compound, the chelating agent and/or the organic acid in a solvent. The solvent includes, for example, water, alcohols, ethers, ketones and aromatic compounds. Particularly, it is desirable to use water as the solvent.

In allowing the chelating agent to act on the metal compound, it is desirable for the mixing amount of the chelating agent to be 0.1 to 2 mols, more desirably 0.3 to 1 mol, per mol of the metal atom contained in the metal compound. Where the mixing amount of the chelating agent is smaller than 0.1 mol, it is impossible to obtain a sufficient effect produced by the addition of the chelating agent, with the result that the catalyst that is finally obtained tends to fail to exhibit improved catalytic activity. On the other hand, where the mixing amount of the chelating agent exceeds 2 mols, the viscosity of the solution is markedly increased, with the result that it is difficult for the catalyst carrier to be impregnated with the solution. It is desirable for the organic acid to be used in a mixing amount substantially equal to that of the chelating agent.

In the solution containing a metal compound and the chelating agent (or the organic acid), the metal compound is to generate metal ions, and the chelating agent (or the organic acid) is coordinated around the metal ion to form a chelate complex. Incidentally, the chelate complex denotes a complex that is formed such that a plurality of ligands each having a ligand atom are arranged to form a ring and are bonded to the central metal.

In order to dissolve stably the metal ion in the solution, it is desirable for the hydrogen ion index (pH value) of the solution to be controlled to fall within a prescribed range. The appropriate pH value is determined depending on the kind of metal. In the case of using, for example, a Co compound or an Ni compound, it is desirable for the pH value of the solution to fall within a range of between 8 and 11, more desirably between 9 and 10. If the pH value of the solution greatly deviates from the range given above, it is difficult to dissolve the metal ions. Alternatively, the solution tends to be rendered unstable such that, after the primary dissolution, the dissolved metal ions are precipitated in a short time.

The pH value of the solution can be set to fall within a prescribed range by adding a pH adjusting agent. An ordinary acid or base can be used as the pH adjusting agent. Where the metal compound is a salt containing an acid or a base, it is desirable for the pH adjusting agent to be equal to the acid or the base because, in this case, the amount of the impurities contained in the catalyst carrier can be decreased.

In the catalyst preparation method according to the embodiment of the present invention, silica used as a carrier is impregnated with the solution containing the chelate complex referred to above. After the impregnation process, the carrier impregnated with the solution is dried and, then, baked.

The specific surface area, the fine pore volume, and the average fine pore diameter of silica used as the carrier are not particularly limited. However, it is desirable for the silica carrier to have a specific surface area not smaller than 100 m²/g, a fine pore volume not smaller than 0.5 mL/g, and an average fine pore diameter not smaller than 10 nm. A silica carrier meeting these conditions is suitable for use in the preparation of a catalyst for the hydrogenating reaction of carbon monoxide. Before impregnation with the solution, the silica carrier should be baked at 500 to 600° C. in an air atmosphere so as to remove the impurities from within the silica carrier.

In allowing the silica carrier to be impregnated with the solution containing a chelate complex, it is possible to employ, for example, a wet impregnating method, a dry impregnating method or an impregnating method under a reduced pressure. In this impregnation process, it is desirable for the amount of the solution used to be equal to the volume corresponding to the pore volume inherent in the porous silica carrier.

Incidentally, in the catalyst prepared by the method according to the embodiment of the present invention, a preferred amount of the transition metal that is supported by the silica carrier is determined in accordance with the kind of transition metal. For example, in the case of using cobalt or iron as the transition metal, it is desirable for the transition metal to be supported by the silica carrier in an amount of 5 to 40% by weight. Also, where the noble metal ruthenium is used as the transition metal, it is desirable for the transition metal to be supported by the silica carrier in an amount of 1 to 10% by weight. Where the supported amount of the transition metal is smaller than the lower limit of the range given above, the conversion rate of carbon monoxide tends to be lowered in the reaction stage of the mixed gas containing hydrogen and carbon monoxide. On the other hand, even if the transition metal is supported by the silica carrier in an amount exceeding the upper limit of the range given above, an improvement corresponding to the supported amount of the transition metal cannot be expected in respect of the conversion rate of carbon monoxide.

It is desirable to determine appropriately the number of impregnating steps so as to permit the transition metal to be supported finally by the silica carrier in the desired amount referred to above. Where the transition metal fails to be supported in the desired amount by a single impregnating step, it is possible to carry out repeatedly the impregnating step and the drying step referred to herein later a plurality of times.

The silica carrier after impregnation with the solution can be molded as desired into, for example, a columnar shape, a three-leaf shape, a four-leaf shape, or a spherical shape.

The drying can be performed by, for example, the drying method under atmospheric pressure or the drying method under reduced pressure. In the case of, for example, the drying method under atmospheric pressure, the drying can be performed at room temperature to 150° C. for 12 to 24 hours in an atmosphere having atmospheric pressure. After the drying step, the baking can be performed at 300 to 500° C. for 2 to 5 hours in an air atmosphere.

By the method described above, it is possible to prepare a catalyst having an oxide of the transition metal capable of hydrogenating carbon monoxide supported by the silica carrier in a highly dispersed state. After an activating treatment is applied by the ordinary method, the catalyst thus obtained can be used for the reaction in Fischer-Tropsch synthesis.

For example, the activating treatment can be performed as follows. Specifically, the catalyst before the activating treatment is loaded in a reactor and gradually heated to 300 to 500° C. while allowing an activating agent to flow through the reactor. The activating agent is formed of hydrogen, carbon monoxide or a synthetic gas containing hydrogen and carbon monoxide. A prescribed actual operating temperature is maintained for 4 to 12 hours within the reactor so as to carry out the activating treatment.

A mixed gas containing hydrogen and carbon monoxide is subjected to reaction at a temperature of 300 to 500° C. and a pressure of 0.1 to 20 MPa in the presence of the catalyst prepared by the method according to the embodiment of the present invention so as to obtain a hydrogenated product containing gasoline fuel oil components or diesel fuel oil components.

To be more specific, the catalyst such as a powdery catalyst is loaded in a cylindrical high pressure reaction tube made of stainless steel, and the reaction tube is heated by, for example, a heater arranged outside the reaction tube to elevate the inner temperature of the reaction tube to 300 to 500° C. Under this condition, a high pressure mixed gas containing hydrogen and carbon monoxide and having a pressure of 0.1 to 20 MPa is allowed to flow through the reaction tube so as to manufacture the hydrogenated product.

It is also possible to manufacture the hydrogenated product by using a slurry prepared by dispersing the powdery catalyst in an organic solvent having a high boiling point. In this case, the slurry is housed in a high pressure tank having inlet and outlet ports, and the tank is heated by, for example, a heater arranged outside the tank so as to elevate the inner temperature of the tank to 300 to 500° C. Under this condition, a high pressure mixed gas containing hydrogen and carbon monoxide and having a pressure of 0.1 to 20 MPa is supplied into the slurry through the inlet port of the tank so as to manufacture the hydrogenated product.

The catalyst prepared by the method according to the embodiment of the present invention is used in general in the form of a powder having an average particle diameter of, for example, 50 to 150 μm. It is also possible to use the catalyst in the form of a granular catalyst, which is prepared by molding the powdery catalyst into pellets, followed by pulverizing the pellets.

It is desirable for the mixing ratio of hydrogen (H₂) to carbon monoxide (CO), i.e., H₂:CO, in the mixed gas to be set at 1 to 4:1, though it is difficult to define the mixing ratio unconditionally because the mixing ratio is dependent on, for example, the intended components of the hydrogenated product. For example, where the diesel fuel oil components constitute the intended components of the hydrogenated product, it is desirable to use a mixed gas containing hydrogen (H₂) and carbon monoxide (CO) mixed at a mixing ratio (H₂:CO) of 2:1.

It is possible to select optionally the intended components of the hydrogenated product from among the C₁ to C₄ components of methane to butane, C₅ to C₉ gasoline fuel oil components and C₁₀ to C₂₀ diesel fuel oil components, and paraffin having a high boiling point such as wax by setting the temperature and pressure to fall within the ranges referred to previously in the reaction system for reacting the mixed gas in the presence of the catalyst prepared by one embodiment of the method of the present invention.

The conversion rate of carbon monoxide is affected by the flow rate of the mixed gas when the mixed gas is supplied into the high pressure reaction tube. If the flow rate of the mixed gas is low, the conversion rate of carbon monoxide is increased in general. However, the distribution of the components of the manufactured hydrogenated product is also changed so as to change the yield of the intended components. Such being the situation, it is desirable for the flow rate of the mixed gas to be set at 50 to 100 cm³/min under a pressure of 0.1 MPa and at a temperature of 20° C. in order to increase the yield of the intended components, i.e., in order to increase the selectivity.

The present invention will now be described in more detail with reference to Examples of the present invention.

### EXAMPLE 1

Prepared was SiO₂ (JRC-SIO-5) as a carrier for supporting the transition metal. The silica carrier had a specific surface area of about 200 m²/g, a fine pore volume of about 1.0 mL/g and an average fine pore diameter of about 15 nm.

The silica carrier was baked at 550° C. for about 120 minutes in an air atmosphere to remove impurities. On the other hand, a solution containing cobalt as the transition metal was prepared as follows.

Specifically, 1.0 mL of water that had been distilled twice was put in a graduated flask having an inner volume of 5 mL, and 0.8 g of NTA as a chelating agent was dispersed in the distilled water. Then, 1.0 mL of water containing 28% by mass of ammonia was added to the dispersion so as to dissolve NTA. Further, 1.23 g of cobalt nitrate was put in the graduated flask so as to be dissolved in the solution, followed by pouring water that had been distilled twice into the graduated flask so as to prepare 5 mL of an aqueous solution (impregnating solution). The pH value of the impregnating solution was found to be 9.5.

The solution in an amount of 1.0 mL was maintained at about 10° C., and the silica carrier was impregnated with the solution for about 10 minutes so as to permit 5% by weight of cobalt to be supported by the silica carrier.

The silica carrier impregnated with the solution was dried at 393 K for 12 hours in an air atmosphere, followed by baking the carrier at 623 K for 4 hours in an air atmosphere so as to prepare (NTA-Co) catalyst.

### EXAMPLE 2

A solution was prepared as in Example 1, except that 1.24 g of EDTA was used in place of NTA. Cobalt as the transition metal and EDTA as a chelating agent were contained in the same molar amounts in the solution.

An (EDTA-Co) catalyst was prepared as in Example 1, except that the solution thus prepared was used for the preparation of the catalyst.

### EXAMPLE 3

A solution was prepared as in Example 1, except that 1.55 g of CyDTA was used in place of NTA. Cobalt as the transition metal and CyDTA as a chelating agent were contained in the same molar amounts in the solution.

A (CyDTA-Co) catalyst was prepared as in Example 1, except that the solution thus prepared was used for the preparation of the catalyst.

### EXAMPLE 4

A solution was prepared as in Example 1, except that 0.31 g of glycine was used in place of NTA. Cobalt as the transition metal and glycine as an organic acid were contained in the same molar amounts in the solution.

A (Glycine-Co) catalyst was prepared as in Example 1, except that the solution thus prepared was used for the preparation of the catalyst.

### EXAMPLE 5

A solution was prepared as in Example 1, except that 0.55 g of L-aspartic acid was used in place of NTA. Cobalt as the transition metal and L-aspartic acid as an organic acid were contained in the same molar amounts in the solution.

An (Aspartic-Co) catalyst was prepared as in Example 1, except that the solution thus prepared was used for the preparation of the catalyst.

### EXAMPLE 6

A solution was prepared as in Example 1, except that 0.87 g of citric acid was used in place of NTA. Cobalt as the transition metal and citric acid as an organic acid were contained in the same molar amounts in the solution.

A (Citric-Co) catalyst was prepared as in Example 1, except that the solution thus prepared was used for the preparation of the catalyst.

### Comparative Example

A solution was prepared as in Example 1, except that NTA was not dissolved in the solution. Then, a (Co) catalyst was prepared as in Example 1, except that the solution thus prepared was used for the preparation of the catalyst.

Each of the catalysts thus obtained was housed in a high pressure fixed-bed flow type reactor so as to be subjected to a pretreatment of reduction at 773 K in a hydrogen gas stream. Then, a mixed gas containing hydrogen and carbon monoxide was introduced into the reactor and subjected to FT synthesis under the conditions given below so as to manufacture a hydrogenated product:
Reaction temperature: 503 K
Total pressure: 1.1 MPa
H₂/CO=2
W/F=5 g-cat h/mol

XRD and the hydrogen adsorption amount were measured for each of the catalysts 6 hours after reduction so as to examine the activity, the selectivity and the crystalline diameter. Table 1 shows the results.

TABLE 1

| | | | | | | Diameter |
|---|---|---|---|---|---|---|
| | CO | | | | | of Co₃O₄ |
| | Conversion | Selectivity (%) | | | | crystal |
| Catalyst | rate (%) | CO₂ | CH₄ | C₅₊ | α | grain (nm) |
| NTA-Co | 53.4 | — | 12.7 | 74.2 | 0.82 | 12 |
| EDTA-Co | 32.5 | — | 8.8 | 78.9 | 0.83 | 15 |
| CyDTA-Co | 40.0 | 0.9 | 16.1 | 68.6 | 0.79 | 10 |
| Glycine-Co | 32.6 | — | 10.5 | 62.9 | 0.81 | 11 |
| Asparatic-Co | 41.4 | — | 11.7 | 66.3 | 0.81 | 10 |
| Citric-Co | 16.6 | — | 10.2 | 59.5 | 0.77 | 9 |
| Co | 17.9 | 0.7 | 8.4 | 79.2 | 0.86 | 19 |

As shown in Table 1, the conversion rate was lower than 20% in the case of using the Co/SiO₂ catalyst (Comparative Example) prepared by using a solution that did not contain a chelating agent. On the other hand, the activity was improved in the case of using any of the catalysts prepared by using a solution containing a chelating agent or an organic acid. Particularly, in the case of using a catalyst prepared by using a solution containing NTA, the CO conversion rate was increased to a level about three times as high as that in the case of using the Co/SiO₂ catalyst. The selectivity of the formed product is also changed in the case of using a catalyst prepared by using a solution containing a chelating agent. To be more specific, the selectivity of C_{5—} was decreased, and the selectivity of CH₄ was increased. Formation of the compound having a low molecular weight suggests that Co species were highly dispersed on the silica carrier.

Then, the crystal state of Co was observed by X-ray diffractometry. The crystalline diameter of Co₃O₄ was calculated using Scheller's equation, with the result as shown in Table 1 above. The catalyst prepared by using a solution containing a chelating agent was found to be smaller in crystalline diameter than the catalyst prepared by using a solution that did not contain a chelating agent. The experimental data suggest that Co species are highly dispersed on the silica carrier in the case of using a solution containing a chelating agent.

Also, a correlation is observed between the crystalline diameter and the chain growth probability, and the molecular weight of the formed product is lowered in the case where Co species are highly dispersed.

Then, the amount of the metal Co contained in the reducing catalyst was obtained by measuring the hydrogen adsorption amount so as to calculate turnover frequency (TOF) and to look into the effect produced by the addition of the chelating agent.

Table 2 shows the hydrogen adsorption amount and TOF for each of the catalysts after the reduction.

TABLE 2

| | H₂ adsorption amount | TOF |
|---|---|---|
| Catalyst | (μmol H₂/g) | (×10⁴s⁻¹) |
| NTA-Co | 65.0 | 17.0 |
| EDTA-Co | 37.9 | 17.7 |
| CyDTA-Co | 35.6 | 17.0 |
| Glycine-Co | 39.4 | 17.1 |
| Asparatic-Co | 49.5 | 17.3 |
| Citric-Co | 20.9 | 16.4 |
| Co | 20.3 | 16.5 |

The hydrogen adsorption amount of the catalyst is increased in the case of using a solution containing a chelating agent for the preparation of the catalyst. A correlation is observed between the hydrogen adsorption amount and the CO conversion rate, and each catalyst exhibited a similar value of TOF. The experimental data suggest that the increase in the CO conversion rate that is achieved in the case of using a solution containing a chelating agent is derived from the increase in the number of active sites, not from the change in the quality of the active site.

The effect produced by the addition of the chelating agent to the impregnating solution was examined. It should be noted that the intensity of the interaction between SiO₂ and the Co species (i.e., the particle diameter of the Co species) is dependent on the pH value of the impregnating solution. To be more specific, the state of the silanol group on the surface of the SiO₂ particle is changed as shown below at the isoelectric point:

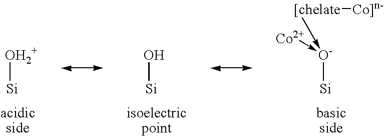

In general, the cobalt nitrate solution is positioned on the basic side relative to the isoelectric point. Also, on the strongly basic side (e.g., where cobalt acetate is used as a precursor), an interaction is strongly produced between the divalent cobalt and SiO—. In this case, the reduction to the metal is rendered difficult, though the crystalline diameter is decreased, with the result that a large amount of Co₂SiO₄ that does not exhibit FT activity is formed. It follows that, in order to activate the catalyst, it is necessary to apply a reducing treatment to the catalyst in high temperatures not lower than 500° C.

On the other hand, the chelate complex used in the method according to the embodiment of the present invention has a negative charge. The particular chelate complex does not produce a strong interaction with the silanol group and, thus, Co₂SiO₄ or the like is not formed. Also, since the chelate complex has a large molecular size compared with cobalt nitrate, it is considered reasonable to understand that the sintering of the metal is not generated in the drying and baking stages to generate the highly dispersed cobalt species.

It is possible to further increase the activity of FT catalyst by changing the pH value of the impregnating solution containing the chelating agent or by changing the molecular size of the chelate complex.

As described in detail above, the present invention provides a preparation method of catalysts for Fischer-Tropsch synthesis (FT synthesis), which permit achieving a high CO conversion rate and which exhibit high activity.

The present invention is useful in industries in which the hydrocarbon obtained as a main product of Fischer-Tropsch synthetic reaction is utilized as a fuel or as a raw material in a chemical reaction, i.e., in industries related to energy and the in chemical industries.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A preparation method of catalysts for Fischer-Tropsch synthesis comprising:
preparing a solution containing a chelate complex having a transition metal capable of hydrogenating carbon monoxide;
allowing silica as a carrier to be impregnated with the solution;
drying the silica carrier impregnated with the solution; and
baking the silica carrier after the drying so as to permit the oxide of the transition metal to be supported by the silica carrier.

2. The preparation method of catalysts for Fischer-Tropsch synthesis according to claim 1, wherein at least one metal selected from the group consisting of cobalt, nickel, iron, copper, chromium, manganese, zirconium, molybdenum, tungsten, rhenium, osmium, iridium, palladium, silver, ruthenium, rhodium, and platinum is used as the transition metal.

3. The preparation method of catalysts for Fischer-Tropsch synthesis according to claim 1, wherein the solution containing the chelate complex is obtained by dissolving a metal compound having the transition metal and a chelating agent in a solvent.

4. The preparation method of catalysts for Fischer-Tropsch synthesis according to claim 3, wherein the chelating agent is selected from the group consisting of nitrilotriacetic acid, trans-1,2-cyclohexadiamine-N,N,N′,N′-tetraacetic acid, and ethylenediamine tetraacetic acid.

5. The preparation method of catalysts for Fischer-Tropsch synthesis according to claim 3, wherein the chelating agent is used in an amount of 0.1 to 2 mols per mol of the transition metal.

6. The preparation method of catalysts for Fischer-Tropsch synthesis according to claim 1, wherein the solution containing the chelate complex is obtained by dissolving a metal compound having the transition metal and an organic acid in a solvent.

7. The preparation method of catalysts for Fischer-Tropsch synthesis according to claim 6, wherein at least one compound selected from the group consisting of glycine, aspartic acid, and citric acid is used as the organic acid.

8. The preparation method of catalysts for Fischer-Tropsch synthesis according to claim 6, wherein the organic acid is used in an amount of 0.1 to 2 mols per mol of the transition metal atoms.

9. The preparation method of catalysts for Fischer-Tropsch synthesis according to claim 3, wherein at least one compound selected from the group consisting of nitrates, carbonates, organic acids, oxides, hydroxides, halides, cyanides, hydroxide, and halide is used as the metal compound having the transition metal.

10. The preparation method of catalysts for Fischer-Tropsch synthesis according to claim 1, wherein cobalt constitutes the transition metal.

11. The preparation method of catalysts for Fischer-Tropsch synthesis according to claim 10, wherein the pH value of the solution containing the chelate complex is adjusted to 8 to 11.
